(19) United States
(12) Patent Application Publication
(10) Pub. No.: US 2004/0107205 A1
(43) Pub. Date: Jun. 3, 2004

(54) Boolean rule-based system for clustering similar records

(75) Inventors: Douglas R. Burdick, Ithaca, NY (US); Steven Rostedt, Endwell, NY (US); Robert J. Szczerba, Endicott, NY (US)

Correspondence Address: TAROLLI, SUNDHEIM, COVELL & TUMMINO L.L.P., 526 SUPERIOR AVENUE, SUITE 1111, CLEVEVLAND, OH, 44114, US

(73) Assignee: Lockheed Martin Corporation

(21) Appl. No.: 10/308,740

(22) Filed: Dec. 3, 2002

(51) Int. Cl. G06F 17/00; G06F 7/00

(52) U.S. Cl. 707/102

(57) ABSTRACT

A system identifies similar records. The system includes a collection of records, a set of Boolean rules, and a cell list structure. Each record in the collection has a list of fields and data contained in each field. The set of Boolean rules operate upon the data in each field. The cell list structure is generated from the collection of records. The cell list structure has a list of cells for each field and a list of pointers to each cell of the list of cells for each record. The set of Boolean rules identifies the similar records from the cell list structure.

### FIELD OF THE INVENTION

The present invention relates to a system for cleansing data, and more particularly, to a system for clustering records obtained from electronic data.

### BACKGROUND OF THE INVENTION

In today's information age, data is the lifeblood of any company, large or small; federal, commercial, or industrial. Data is gathered from a variety of different sources in various formats, or conventions. Examples of data sources may be: customer mailing lists, call-center records, sales databases, etc. Each record from these data sources contains different pieces of information (in different formats) about the same entities (customers in the example case). Each record from these sources is either stored separately or integrated together to form a single repository (i.e., a data warehouse or a data mart). Storing this data and/or integrating it into a single source, such as a data warehouse, increases opportunities to use the burgeoning number of data-dependent tools and applications in such areas as data mining, decision support systems, enterprise resource planning (ERP), customer relationship management (CRM), etc.

The old adage “garbage in, garbage out” is directly applicable to this environment. The quality of the analysis performed by these tools suffers dramatically if the data analyzed contains redundant values, incorrect values, or inconsistent values. This “dirty” data may be the result of a number of different factors including, but certainly not limited to, the following: spelling errors (phonetic and typographical), missing data, formatting problems (incorrect field), inconsistent field values (both sensible and non-sensible), out of range values, synonyms, and/or abbreviations. Because of these errors, multiple database records may inadvertently be created in a single data source relating to the same entity or records may be created which don't seem to relate to any entity. These problems are aggravated when the data from multiple database systems is merged, as in building data warehouses and/or data marts. Properly combining records from different formats becomes an additional issue here. Before the data can be intelligently and efficiently used, the dirty data needs to be put into “good form” by cleansing it and removing these errors.

A naïve method may involve performing an extensive string comparison step for every possible record pair, as illustrated in FIG. 20. A similarity function compares each record pair against each other and the resulting “similarity score” is shown in the corresponding grid cells. An example threshold score value of at least 75 results has been assumed in considering the two records to be duplicates.

For n records to be processed, approximately n\hat{ }2/2 comparisons are performed (or approximately ½ of the cells in the grid). Thus, for a moderate sized database with 1 million records, approximately 500 billion comparisons could be performed. As a result, this process is computationally infeasible for all but the smallest record collections. The advantage of this approach is that it will detect every duplicate that the comparison function would, since all of the possible comparisons are performed.

In FIG. 20, many cell values (corresponding to the score for a record pair comparison) are very low for the similarity function. Although these comparisons have no reasonable chance actually being similar, these comparisons are blindly performed. Alternatively, the number of comparisons performed may be limited to only ones with a reasonable chance of similarity. The challenge is deriving criteria for defining this limitation efficiently.

Intuitively, certain parts of certain record fields have to be identical for two records to have even a remote chance of being considered duplicates, or scoring above the threshold value when compared with the similarity function. For example, when comparing customer address records, it would be reasonable to assume that the first two letters of the last name field, first two letters of the street name field, and the first two letters of the city name field would have to be identical for two records to be considered similar by the similarity function.

FIG. 21 illustrates this technique. These pieces of the three fields may be concatenated together to create a concise representation of the record called a “bucket key”. All records having the same bucket key value have a reasonable chance of actually being duplicates and being grouped, or clustered, together. The similarity function should therefore perform a comparison operation on records with the same bucket key value.

A first difficulty arises with such an approach if the record has mistakes in the parts of the record that make up the bucket key, as shown in FIG. 22. A typographical error in the first two letters of the street name field has lead to the second record having a different bucket key value than the first record and being put in a bucket different from the first record. These records will never be compared to each other, since they are in different buckets, even though they would likely be considered duplicates if compared using a simple similarity function.

One way to attempt to minimize the impact of this first difficulty is to build the bucket key from parts of fields that have minimal chance of typographical errors. For example, in customer address data, the first several letters of the last name and the first 3 digits of the ZIP codes are standard candidates. However, even with carefully selected bucket key components, a single error will eliminate the possibility that the two records will be compared.

A second difficulty with this approach is that if the data has a large number of very similar records, then many records will be placed into a small number of buckets. Since each record in a bucket is compared to every other record in the bucket, this increases the number of comparisons performed (which reduces computational efficiency). This can be avoided by selecting parts of fields for the bucket key that uniquely identify a record (i.e., the address field), so that non-duplicate records will have different bucket key values and will be placed into different buckets.

Both of these difficulties point towards a larger, conceptual problem with this approach. Selection of which parts of which fields make up the bucket key is specialized and highly specific to the type of data. This observation implies that for every different type of application, a different method of bucket key derivation may be necessary to increase efficiency.

Another approach to that of the “bucket key” clustering method is to limit the number of comparisons through the following method: create a bucket key for each record based on the field values; sort the entire database based on the bucket key; and compare records “near” each other in the sorted list using a similarity function. The definition of “near” is what limits the number of comparisons performed. Records are considered near each other if they are within “w” positions of the other records in the sorted list. The parameter “w” defines a window size. Conceptually this can be viewed as a window sliding along the record list. All of the records in the window are compared against each other using the similarity function. Like the bucket key described earlier, this bucket key consists of the concatenation of several ordered fields (or attributes) in the data record.

A weakness of this approach lies in the creating and sorting functions. If errors are present in the records, it is very likely that two records describing the same object may generate bucket keys that would be far apart in the sorted list. Thus, the records would never be in the same window and would never be considered promising candidates for comparison (i.e., they would not be detected as duplicates).

In FIG. 23, the location of the error in the record is the first letter of the last name. The bucket keys that were generated are therefore far apart in the sorted list. Although the records are highly similar (and very likely duplicate records), they will not be compared together as possible duplicates.

Creating a reliable bucket key in a first step depends on the existence of a field with high degree of standardization and low probability of typographical errors, (e.g., in customer records, Social Security Numbers, etc.). Unfortunately, this might not be present for all applications. Additionally, for very large databases (typically found in data warehouses) sorting the records (based on a bucket key) is not computationally feasible.

One conventional advanced approach involves the repeating of the creating and sorting steps for several different bucket keys, and then taking the “transitive closure” of the results for the comparing step from the repeated runs. “Transitive closure” means that if records R1 and R2 are candidates for merging based on window 1, and R2 and R3 are candidates for merging based on window 2, then consider R1 and R3 as candidates for merging. The tradeoff is that while multiple sorts and scans of the databases are needed (significantly increasing the computational complexity), this approach reduces the number of actual record comparisons needed in the comparing step since the “sliding window” may be made smaller.

Many conventional clustering approaches are distance-based approaches that operate by modeling the information in each database record as points in an N-dimensional space. Sets of points “near” each other in this space represent sets of records containing “similar” information.” Typically, each field of a record is assigned a dimension. For example, a record with 20 fields can be modeled as a point in 20 dimensional space, with the value for a dimension based on the value the record has for the corresponding field. A set of points that are less than a certain distance from each other in this space can be placed into groupings called clusters.

These conventional approaches assume some consistent notion of “distance” between each record pair exists, with this “distance” measure based on the similarity of the records. Implicit in this is the existence of a reliable distance measure between the different values for each record field, the field corresponding to a dimension in the N-dimensional space. These methods need a way to quantify the similarity of each pair of field values. If the field information is metric, this is relatively straightforward. Metric data has an “implicit” similarity measure built in, thus quantifying the difference between any two values as trivial. Examples include weight, height, geo-spatial coordinates (i.e., latitude, longitude, altitude, etc.), and temperature. Difference measures are variants on the absolute numerical difference between two values (i.e., the distance between a height of 72 inches and 68 inches is 4, etc.)

Non-metric data does have such an inherently quantifiable distance between each field value pair. Examples of non-metric information include items like telephone numbers, ZIP codes, Social Security numbers, and most categorical data (i.e., race, sex, marital status, etc.). One commonly used distance measure for non-metric data are variants of the edit-distance, which is the minimum number of character insertions, deletions, and substitutions needed to transform one string into another string. The formula may be Edit-distance=(# insertions)+(# deletions)+(# substitutions).

For example, the edit-distance between “Robert” and “Robbert” would be 1 (since the extra ‘b’ was inserted). The edit-distance between “Robert” and “Bobbbert” would be 3 (since the ‘R’ was substituted with the ‘B’ and there was two extra ‘b’s inserted; so there would be 1 substitution and 2 insertions).

Any distance-based similarity measurement will have problems handling errors in the record fields. Each error (or dirtiness in a record) changes the value(s) a particular record has for one or more fields. Thus, the error changes the distance between this record and other records in the collection. If the distance changes enough because of the error, then the record may not be placed in the correct cluster with other similar records, and might not be properly identified as a duplicate record. Alternatively, the opposite can happen, and the record may be incorrectly identified as a duplicate record when in fact it uniquely refers to a real-world object. No single distance function will correctly handle all of the different possible types of errors that may be encountered. These distance-based clustering approaches attempt to “fine-tune” the distance functions used to handle a small number of known, frequent errors (i.e., common typographical errors result in a smaller distance than ordinary differences, etc.). Such fine-tuning makes the distance function very domain specific (i.e., specific to one type of information entered a specific way, etc.). In many situations, such tuning is not possible.

### SUMMARY OF THE INVENTION

In accordance with the present invention, a similarity function may comprise Boolean rules that define which fields (or combinations of fields) must have similar values for the records to be considered likely to describe the same real-world entity. By representing the similarity criteria as Boolean rules, the system or method in accordance with the present invention provides a generalized way for determining which records should be considered “most likely” to represent the same real-world entity.

Conventional systems have limited how field similarity information could be combined together to determine record similarity. As a result, the quality of the clusters created for each record suffered. A system or method in accordance with the present invention solves this problem. Field similarity information may thus be combined as the application demands, and using Boolean rules allows the incorporation of different types of business rules into the similarity criteria.

The system or method in accordance with the present invention does not rely on a “distance measure.” The system relies on combining similarity information together in a non-linear manner. While the similarity information for a particular field may be distance-based, it is not limited to being so (which is an improvement over the conventional approaches). The system assumes the similarity information is given in a form “value A is similar to value B”, and nothing more. The conventional approaches require more information of the form “value A is distance X from value B, for each value of A and B.”

The system or method in accordance with the present invention may further extend and modify the Boolean rule structure to encode any distance function of the conventional distance-based approaches. By using weights and “fine-tuning” the field distances, the conventional approaches may emphasize the importance of a record field relative to the other fields by assigning different weights to the individual distances. A higher weight means the field has greater influence over the final calculated distance than other fields. However, encoding variable levels of field importance for different combinations of field similarity values using these distance-based measures is cumbersome, and not always possible.

The system or method in accordance with the present invention may easily encode such information using Boolean rules. An exponential amount of information may be encoded in each Boolean rule. Additionally, the system may extend the Boolean rules using “fuzzy” logic in order to encode any arbitrary distance function of the conventional approaches. Boolean rules have the advantages of other non-linear approaches (i.e., neural nets, etc.), while also encoding the information in an understandable, algorithmic format.

The system or method accurately determines record similarity. For example, in street addresses, there may a correspondence between (city, state) combinations and ZIP codes. Each (city, state) combination may correspond to a specific ZIP code, and vice versa. The system may consider as similar two records having the same values for the city and state, independent of the ZIP code. The system or method thereby may process records with mistakes in the ZIP code values that were intended to be the same. For example, the addresses “Ithaca, N.Y. 14860” and “Ithaca, N.Y. 14850” are intended to be the same.

Further, in addresses, it is very common to use variants of the city (i.e., “vanity names”), which bear no syntactic similarity to the corresponding city (i.e., “Cayuga Heights” for “Ithaca”, “Hollywood” for “Los Angeles”, etc.). The system or method may process this type of record by considering two records similar if they have the same ZIP code and State, regardless of the value for city name (i.e., “Cayuga Heights, N.Y. 14850” is the same as “Ithaca, N.Y. 14850”). The system or method may be encoded with the Boolean rule (City AND State) OR (ZIP AND State). The conventional approaches do not have this advantage.

The system or method in accordance thus provides a greater robustness against mistakes in the record information. While the example system described below detects duplicate information, the system may also process defective, fraudulent, and/or irregular data in a database as well.

### BRIEF DESCRIPTION OF THE DRAWINGS

The foregoing and other advantages and features of the present invention will become readily apparent from the following description as taken in conjunction with the accompanying drawings, wherein:

FIG. 1 is a schematic representation of one example part of a system for use with the present invention;

FIG. 2 is a schematic representation of another example part of a system for use with the present invention;

FIG. 3 is a schematic representation of still another example part of a system for use with the present invention;

FIG. 4 is a schematic representation of yet another example part of a system for use with the present invention;

FIG. 5 is a schematic representation of still another example part of a system for use with the present invention;

FIG. 6 is a schematic representation of yet another example part of a system for use with the present invention;

FIG. 7 is a schematic representation of the performance of a part of an example system for use with the present invention;

FIG. 8 is a schematic representation of a part of an example system for use with the present invention;

FIG. 9 is a schematic representation of another part of an example system for use with the present invention;

FIG. 10 is a schematic representation of still another part of an example system for use with the present invention;

FIG. 11 is a schematic representation of input for an example system for use with the present invention;

FIG. 12 is a schematic representation of an operation of an example system for use with the present invention;

FIG. 13 is a schematic representation of another operation of an example system for use with the present invention;

FIG. 14 is a schematic representation of output of an example system in accordance with the present invention;

FIG. 15 is a schematic representation of part of an example system in accordance with the present invention;

FIG. 16 is a schematic representation of another part of an example system in accordance with the present invention;

FIG. 17 is a schematic representation of still another part of an example system in accordance with the present invention;

FIG. 18 is a schematic representation of an operation of an example system in accordance with the present invention;

FIG. 19 is a schematic representation of another operation of an example system in accordance with the present invention;

FIG. 20 is a schematic representation of a system for clustering data records;

FIG. 21 is a schematic representation of a system for clustering data records;

FIG. 22 is a schematic representation of an operation of the system of FIG. 21; and

FIG. 23 is a schematic representation of another operation of the system of FIG. 21.

### DETAILED DESCRIPTION OF AN EXAMPLE EMBODIMENT

A system in accordance with the present invention clusters sets of records “possibly” describing the same real-world entity from a record collection. A cluster of records is considered likely to describe the same entity if it meets a “similarity criteria” that is based on the similarity of values in the fields of each record. A similarity criteria in accordance with the present invention uses Boolean rules to define which fields (or combinations of fields) must have similar values for the records to be considered likely to describe the same real-world entity. Information concerning sets of records having similar field values is passed into this system as input. The system takes this information and, for each particular record in the record collection, finds the set of records meeting the Boolean similarity criteria relative to the particular record (corresponding to the “cluster” for that particular record). The output of this system may be used as input to a matching step of a data cleansing system.

One data cleansing system (and supporting data structure) for use with the system of the present invention may identify groups of records that have “similar” values in different records of the same field. “Similar” means that all of the records in the field set would have the same value if the data were free of errors. Such a system is robust to “noise” present in real-world data (despite best attempts at standardization, normalization, and correction). The system may optionally involve the application of sets of transform functions to the fields in each of the records. Additionally, the system creates a data structure to store the similarity information of the associated records for each field.

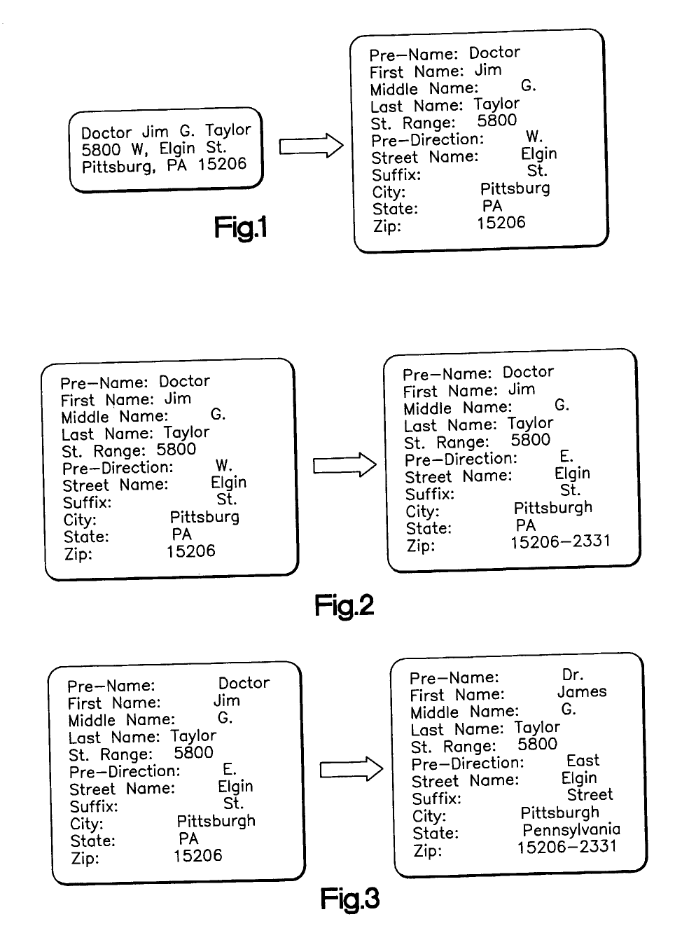

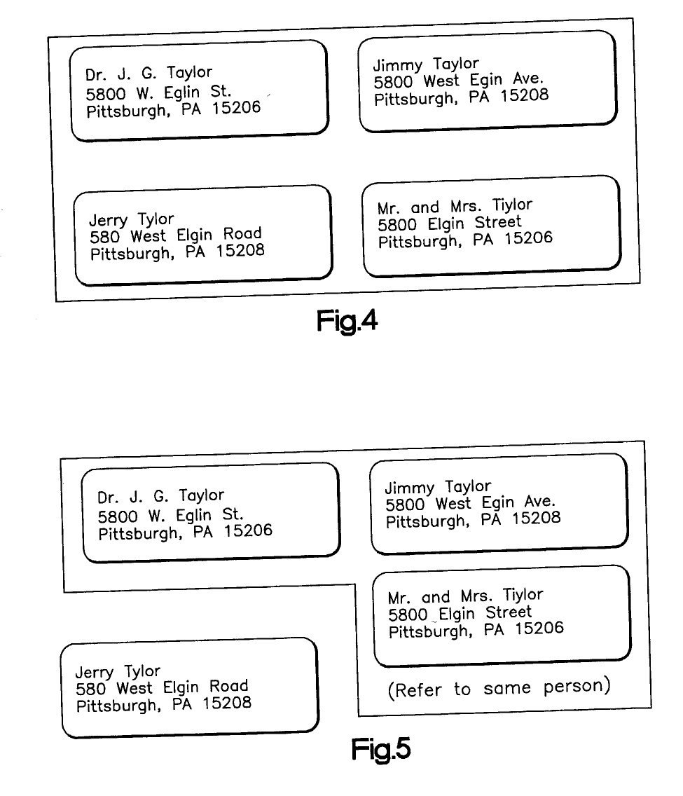

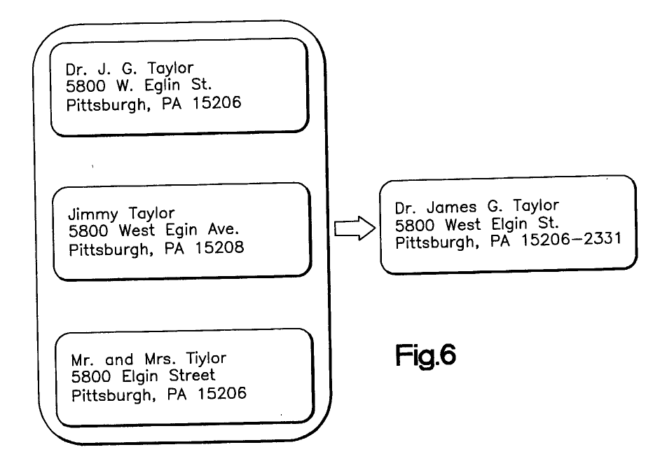

Typically, the data cleansing process can be broken down into the following steps: parsing (FIG. 1); validation/correction (FIG. 2); standardization (FIG. 3); clustering (FIG. 4); matching (FIG. 5); and merging (FIG. 6). Note that different approaches may consolidate these steps or add additional ones, but the process is essentially the same.

As viewed in FIG. 1, parsing may intelligently break a text string into the correct data fields. Typically, the data is not found in an easily readable format and a significant amount of decoding needs to be done to determine which piece of text corresponds to what particular data field. Note that this step does not involve error correction.

Records may be formatted or free form. Formatted records have field values stored in a fixed order, and properly delineated. Free-form records have field values stored in any order, and it may be unclear where one field ends and another begins.

Once the string is parsed into the appropriate fields, the validation step, as viewed in FIG. 2, checks the field values for proper range and/or validity. Thus, a “truth” criteria must be provided as input to this step for each field.

The correction step may update the existing field value to reflect a specific truth value (i.e., correcting the spelling of “Pittsburgh” in FIG. 2). The correction step may use a recognized source of correct data such as a dictionary or a table of correct known values. For certain data, this step might not be feasible or appropriate and may be skipped.

As viewed in FIG. 3, the standardization step may arrange the data in a consistent manner and/or a preferred format in order for it to be compared against data from other sources. The preferred format for the data must be provided as input to this step.

As viewed in FIG. 4, the clustering step may create groups of records likely to represent the same entity. Each group of records is termed a cluster. If constructed properly, each cluster contains all records in a database actually corresponding to a unique entity. A cluster may also contain some other records that correspond to other entities, but are similar enough to be considered. Preferably, the number of records in the cluster is very close to the number of records that actually correspond to the entity for which the cluster was built.

As viewed in FIG. 5, the matching step may identify the records in each cluster that actually refer to the same entity. The matching step searches the clusters with an application specific set of rules and utilizes a computational intensive search algorithm to match elements in a cluster to the unique entity. For example, the three indicated records in FIG. 5 likely correspond to the same person or entity, while the fourth record may be considered to have too many differences and likely represents a second person or entity.

As viewed in FIG. 6, the merging step may utilize information generated from the clustering and matching steps to combine multiple records into a unique (and preferably the most correct) view of each entity. The merging step may take data from fields of different records and “fuse” them into one, thereby providing the most accurate information available about the particular entity. The intelligent merging of several records into a single consolidated record ideally creates a new record that could replace the duplicate record cluster it was generated from without loss of any information.

In the clustering and matching steps, algorithms identify and remove duplicate or “garbage” records from the collection of records. Determining if two records are duplicates involves performing a similarity test that quantifies the similarity (i.e., a calculation of a similarity score) of two records. If the similarity score is greater than a certain threshold value, the records are considered duplicates.

Most data cleansing approaches limit the number of these “more intensive” comparisons to only the “most promising” record pairs, or pairs having the highest chance of producing a match. The reasoning is that “more intensive” comparisons of this type are generally very computationally expensive to perform. Many record pairs have no chance of being considered similar if compared (since the records may be very different in every field), thus the expensive comparison step was “wasted” if we simply compare every pair of records. The trade-off for not performing the “more intensive” inspection for every record pair is that some matches may be missed. Record pairs cannot have high enough similarity scores if the similarity score is never calculated.

For an example description of a system in accordance with the present invention, assume the record data is given, including format of the data and type of data expected to be seen in each record field. The format and type information describes the way the record data is conceptually modeled.

Each record contains information about a real-world entity. Each record can be divided into fields, each field describing an attribute of the entity. The format of each record includes information about the number of fields in the record and the order of the fields. The format also defines the type of data in each field (for example, whether the field contains a string, a number, date, etc.).

The clustering step produces a set of records “possibly” describing the same real-world entity. This set ideally includes all records actually describing that entity and records that “appear to” describe the same entity, but on closer examination may not. This step is similar to a human expert identifying similar records with a quick pass through the data (i.e., a quick pass step).

The matching step produces duplicate records, which are defined as records in the database actually describing the same real-world entity. This step is similar to a human expert identifying similar records with a careful pass through the data (i.e., a careful pass step).

The concepts of correctness using the terms “possibly describing” and “actually describing” refer to what a human expert would find if she/he examined the records. A system in accordance with the present invention is an improvement in both accuracy and efficiency over a human operator.

If constructed properly, each cluster contains all records in a database actually corresponding to the single real-world entity as well as additional records that would not be considered duplicates, as identified by a human expert. These clusters are further processed to the final duplicate record list during the matching step. The clustering step preferably makes few assumptions about the success of the parsing, verification/correction, and standardization steps, but performs better if these steps have been conducted accurately. In the clustering step, it is initially assumed that each record potentially refers to a distinct real-world entity, so a cluster is built for each record.

The example system may utilize transform functions to convert data in a field to a format that will allow the data to be more efficiently and accurately compared to data in the same field in other records. Transform functions generate a “more basic” representation of a value. There are many possible transform functions, and the following descriptions of simple functions are examples only to help define the concept of transform functions.

A NONE (or REFLEXIVE) function simply returns the value given to it. For example, NONE(James)=James. This function is not really useful, but is included as the simplest example of a transform function.

A SORT function removes non-alphanumerical characters, sorts all remaining characters in alphabetic or numerical order. For example, SORT (JAMMES)=aejmms, SORT(JAMES)=aejms, SORT (AJMES)=aejms. This function corrects, or overcomes, typical keyboarding errors like transposition of characters. Also, this function corrects situations where entire substrings in a field value may be ordered differently (for example, when dealing with hyphenated names: SORT(“Zeta-Jones”) returns a transformed value which is identical to SORT(“Jones-Zeta”).

A phonetic transform function gives the same code to letters or groups of letters that sound the same. The function is provided with basic information regarding character combinations that sound alike when spoken. Any of these “like sounding” character combinations in a field value are replaced by a common code, (e.g., “PH” sounds like “F”, so you give them both the same code of “F”). The result is a representation of “what the value sounds like.”

The goal is to find a criteria for identifying the “most promising” record pairs that is both lax enough to include all record pairs that actually match while including as few non-matching pairs as possible. As the criteria for “most-promising” record is relaxed, the number of non-matching pairs increases, and performance suffers. A strict criteria (i.e., only identical values deemed duplicate) improves performance, but may result in many matching records being skipped (i.e., multiple records for the same real-world entity).

The preferable criteria for identifying “most promising” record pair comparisons has to be flexible enough to handle the various sources of “noise” in the data that causes the syntactic differences in records describing the same entity (despite the best efforts at Standardization and Correction, or in cases where these steps are impossible). Noise represents the errors present in the data causing the syntactical differences between records describing the same objects (i.e., causes records to inappropriately have different values for the same field).

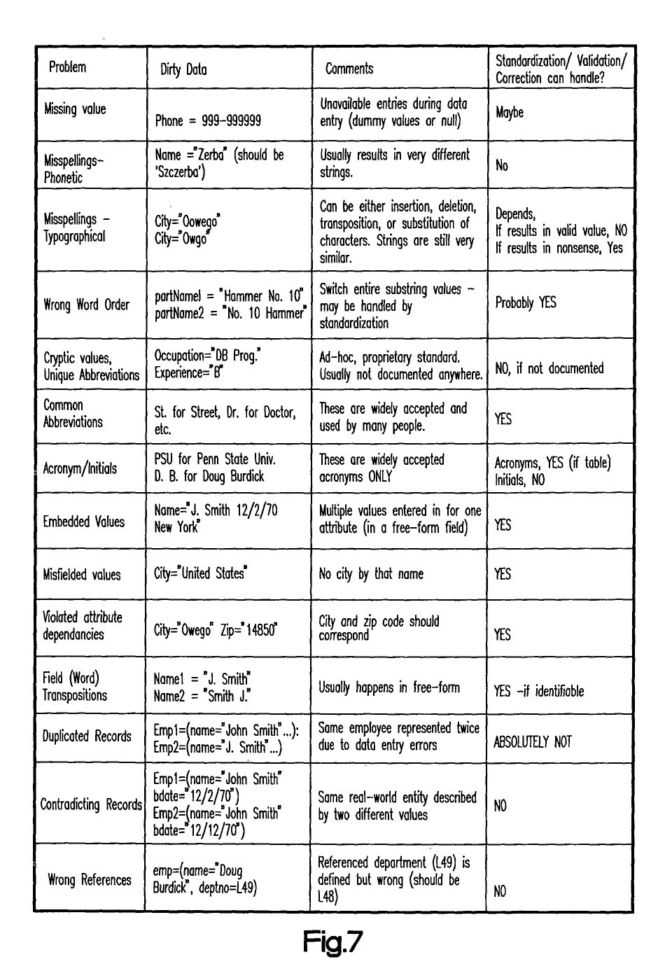

Examples of the types of errors that create noise typically found in practical applications are illustrated in FIG. 7. The standardization and validation/correction steps cannot overcome or detect some types of errors. This list is far from exhaustive and is meant for illustrative purposes only. The types of noise found in a particular record depend upon attributes such as the following: the source from which a record is created (keyboarded, scanned in, taken over phone, etc.); the type of value expected to be found in the field (numerical, alphabetical, etc.); and the type of information found in the field (addresses, names, part serial numbers, etc.).

Usually the criteria for “most promising” record pairs involves information about whether or not the record pair has the same (or highly similar) value for one or more record fields. The theory is that records describing the same real-world entity would be very similar syntactically, possibly identical, if there was no noise in the record data.

To overcome noise, a system may accomplish the following two objectives: (1) identifying the field values that are “similar” (these values may be identical if there is no noise in the data; these values are close enough syntactically that it would be reasonable to assume that they may have been intended to be identical, but due the noise of the data, they are not); (2) for each field of the record, representing (and storing) information about the sets of records that were determined to have a similar value for the field.

An example system 10 may address both objectives by identifying field values that have similar values through the application of one or more transform functions to the value of that particular field in each of the records. The system 10 may also include a structure to store information for each of the fields with “similar” values. This identification typically occurs in the clustering step.

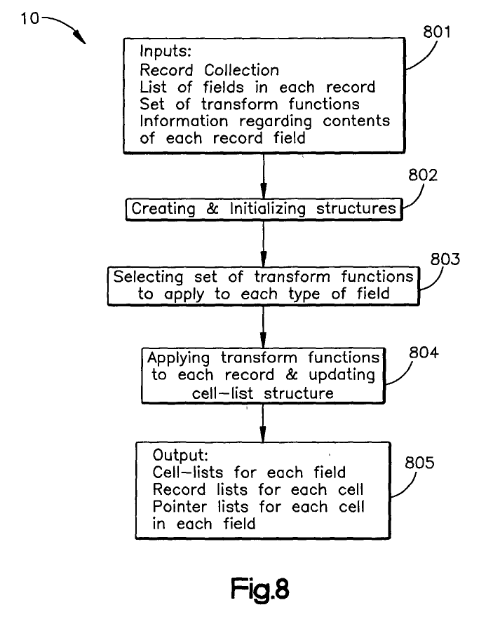

A high-level description of the example system 10 is illustrated in FIG. 8. The inputs 801 to the system 10 are the record collection, the list of fields in each record, the set of transform functions chosen for this particular record collection, and information regarding the contents of each record field (if available). The record collection is the set of records on which the system 10 is applied and may be a single set of records or a plurality of records lumped together. The list of fields in each record is assumed by the system 10 to be the same (or common) for all of the records.

Each transform function operates on a particular field value in each record. The set of transform functions is the set of all transform functions available for the system 10 to possibly use. Some transform functions may be applied to multiple fields, while others may not be used at all. Each field will have the most appropriate subset of these functions applied to it. Different functions may be applied to different fields. The information regarding the contents of each record field describes the types of information in the field. This information may be useful in determining which transform functions to apply to which type of record field. This information may or may not be available.

There are potentially thousands of transform functions available to the system, each handling a different type of error. Generally, only a small number of functions should be applied to a field. A transform function may be applied to several fields or to none.

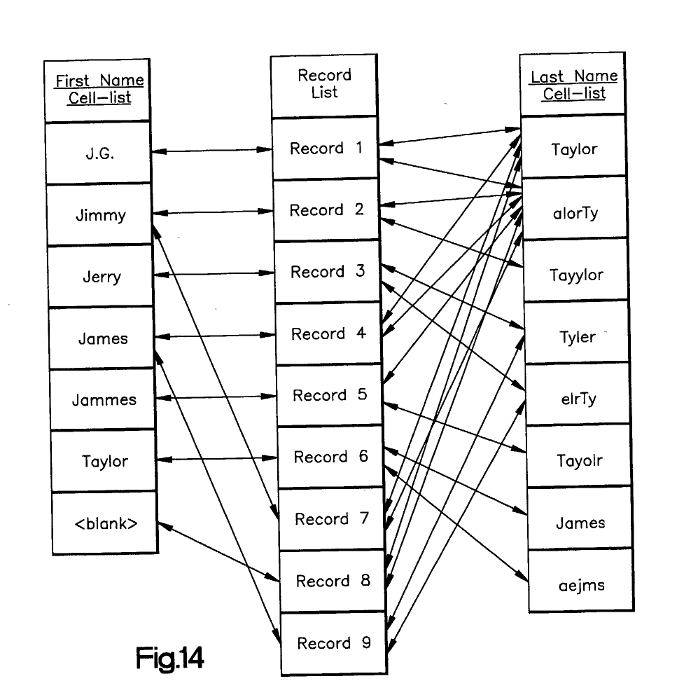

Fields may also be grouped together that would likely to have switched values (e.g., first name and last name may be swapped, especially if both values are ambiguous—for example John James). The values in these grouped fields would be treated as coming from a single field. Thus, all of the transform function outputs for the field group would be compared against each other (See FIG. 14).

Determining what transforms to apply to each field and which fields should be grouped together can be done numerous ways. Examples include, but certainly are not limited to: analyzing the values in the record fields using a data-mining algorithm to find patterns in the data (for example, groups of fields that have many values in common); and based on the types of known errors found during the standardization and correction steps, select transform functions to handle similar errors that might have been missed. Further, based on errors parsing the record, fields likely to have values switched may be determined, and thus should be grouped together.

Another example includes using outside domain information. Depending on the type of data the record represents (e.g., customer address, inventory data, medical record, etc.) and how the record was entered into the database (e.g., keyboard, taken over phone, optical character recognition, etc.), certain types of mistakes are more likely than others to be present. Transform functions may be chosen to compensate appropriately.

The transform functions may be adaptively applied as well. For example, if there is a poor distribution of transformed values, additional transforms may be applied to the large set of offending records to refine the similarity information (i.e., decrease the number of records with the same value). Alternatively, a “hierarchy of similarity” may be constructed, as follows: three transform functions, T1, T2, T3, each have increasing specificity, meaning that each transform function separates the records into smaller groups. T3 separates records more narrowly than T2, and T2 separates records more narrowly than T1. Thus, the more selective transform function assigns the same output to a smaller range of values. Intuitively, this means that fewer records will have a value for the field that generates the same output value when the transform function is applied, so fewer records will be considered similar.

An example illustrating this concept, for illustrative purposes only, is described, as follows: Firstly, T1 is applied to Field 1 of the record collection. For any group of records larger than 20 that are assigned the same value by T1, T2 is applied to Field 1 of these “large” sized record groups. From this second group, if any group of records larger than 10 are assigned the same value by T2, then T3 is applied to Field 1 of these “medium” sized record groups.

Therefore, an iterative process may use feedback from multiple passes to refine the similarity information. Only as many functions as needed are applied to refine the similarity data, which increases efficiency of the application and prevents similarity information from being found that is too “granular” (splits records into too small groups).

Additionally, composite transform functions, or complex transform functions, may be applied that are built from a series of simpler transforms. For example, a transform function TRANS-COMPLEX that removes duplicate characters and sorts the characters alphabetically may be defined. TRANS-COMPLEX may be implemented by first performing a REMOVE-DUPLICATES function followed by a SORT function (described above). For example, TRANS-COMPLEX(JAMMES)=aejms and TRANS-COMPLEX(JAMMSE)=aejms.

A “fuzzy” notion of similarity may be introduced. A “fuzzy” similarity method uses a function to assign a similarity score between two field values. If the similarity score is above a certain threshold value, then the two values are considered good candidates to be the same (if the “noise” was not present).

The assigned similarity score may be based on several parameters. Examples of drivers for this similarity value are given below. These are only illustrate the form drivers may take and provide a flavor of what they could be.

A first driver may assign several transform functions to a field. A weight may be assigned to each transform function. The weight reflects how informative a similarity determination under this transform function actually is. If the transform function assigns the same output to many different values, then the transform function is very general and being considered “similar” by this transform function is less informative than a more selective function. A hierarchy of transform functions is thereby defined.

A second driver also may assign a similarity value between outputs from the same transform function. Slightly different output values might be considered similar. The similarity of two values may then be dynamically determined.

A third driver may dynamically assign threshold values through the learning system that selects a transform function. Threshold values may be lowered since similarity in some fields means less than similarity in other fields. This may depend on the selectivity of the fields (i. e., the number of different values the field takes relative to the record).

A fourth driver may incorporate correlations/patterns between field values across several fields into the assigning of similarity threshold values. For example, with street addresses, an obvious pattern could be derived by a data mining algorithm where city, state, and ZIP code are all related to each other, (i.e., given a state and a ZIP code, one can easily determine the corresponding city). If two records have identical states and ZIP values, a more lenient similarity determination for the two city values would be acceptable. Bayesian probabilities may also be utilized (i. e., if records A and B are very similar for field 1, field 2 is likely to be similar).

The functioning of the system 10 may be segregated into the following three steps: creating and initializing 802 the structures the system 10 will use; selecting 803 the appropriate set of transform functions to apply to each type of field (while many transform functions may be available, only a few are appropriate for the type of data for any one field; only these transform functions should be used; some functions may be used for multiple fields, while others may not be used at all; different functions can be applied to different fields; there are numerous acceptable ways to implement this step); and applying 804 the transform functions to each record by applying the appropriate transform functions to each field in each record and updating the resulting cell-list structure appropriately.

The output 805 of the system 10 is the completed cell-list structure for the record collection, representing information for each of the fields and sets of records having similar values for that field. The structure includes a cell-list for each field of each record. Each cell-list contains the name of the field for which the cell list was built and a list of cells. Each cell-list contains a value for the field of the cell-list containing it and a list of pointers to records containing that cell value in that field. All of the pointers generate a cell's value when one of the transform functions is applied to the field of each record.

The cell-list structure further includes a set of pointer lists, one for each field. Each pointer points to a cell. All of the pointers in a pointer list point to cells in the same cell-list. Each cell pointed to is in the cell-list.

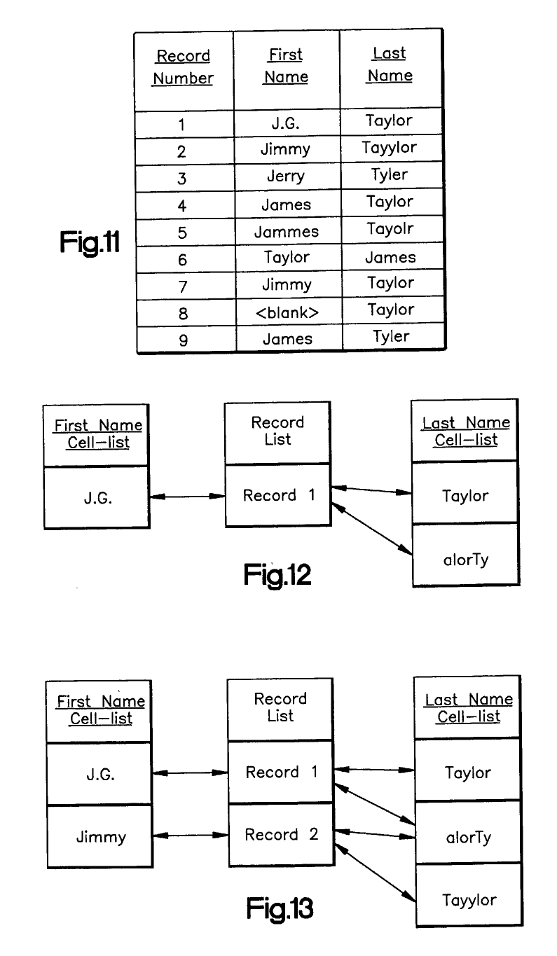

An example of a completed cell-list structure is illustrated in FIG. 14. A sample record collection from which the cell-list structure was generated is illustrated in FIG. 11. The middle column of FIG. 14 illustrates a list of records. Record number 1 in FIG. 11 corresponds to record 1 of the middle column and so on. The cell-lists for the First Name and Last Name fields are the left and right columns of FIG. 14, respectively. Each cell is labeled with the value associated with it. The generation of these values is described below.

The arrows in FIG. 14 represent pointers between cells. Cells point to appropriate records and records point to appropriate cells (each single bi-directional arrow in FIG. 14 may also be represented by two arrows each going in a single direction).

As described above, at the highest level, the example system 10 may be segregated into the five steps illustrated in FIG. 8. In step 801, the system 10 provides the inputs, as follows: a record collection; a list of fields in each record; a set of transform functions; and information about field contents, if available. Following step 801, the system 10 proceeds to step 802. In step 802, the system 10 creates cell-list structures for each of the fields, and initializes them to empty. For each record in the record collection, a record is created. The pointer list for each of the records is initialized to empty. Following step 802, the system 10 proceeds to step 803. In step 803, the system 10 selects appropriate transform functions to apply to each field in each record. There are numerous ways to implement a system for selecting which transform functions to apply to each field from any given set of transform functions. While there may be a multitude of transform functions, only a handful may be appropriate to apply to any particular field. Generally, choosing functions to apply to a field involves some domain-dependent knowledge. Not all of the transform functions are applied to each field, only ones that make sense given the expected types of errors in the data.

Alternatively, the same transform function may be applied to multiple fields, if appropriate. For example, data entered by keyboard likely contains typographical errors, while data records received from telephone calls would more likely contain phonetic spelling errors. Suitable transform functions result in standardized values tailored to these error sources.

Transforms functions operate on values in particular fields where fields are defined in the record format. The transform functions are chosen to help overcome clerical errors in field values that might not (or cannot) be caught during the standardization step, such as those illustrated in FIG. 7.

Errors that result in valid, but incorrect field values typically cannot be determined. For example, in the example record set in FIG. 11, record 5 has the value “Jammes” for the FirstName field. The value “Jammes” might be a valid name, but not the intended value for this record (the typist inserted an extra character into “James”—a common mistake). The intention of the typist cannot be checked, only whether the result is valid. Almost all of the errors that standardization/validity/correction cannot determine are of this type. However, these errors result in values that are usually very similar syntactically or phonetically to the intended value (for example, “Jammes” for “James”).

Following step 803, the system 10 proceeds to step 804. In step 804, the system 10 updates the cell list structures through application of the transform functions. Following step 804, the system 10 proceeds to step 805. In step 805, the system 10 provides output, as follows: cell lists for each field; record lists for each cell; pointer lists for each cell in each field.

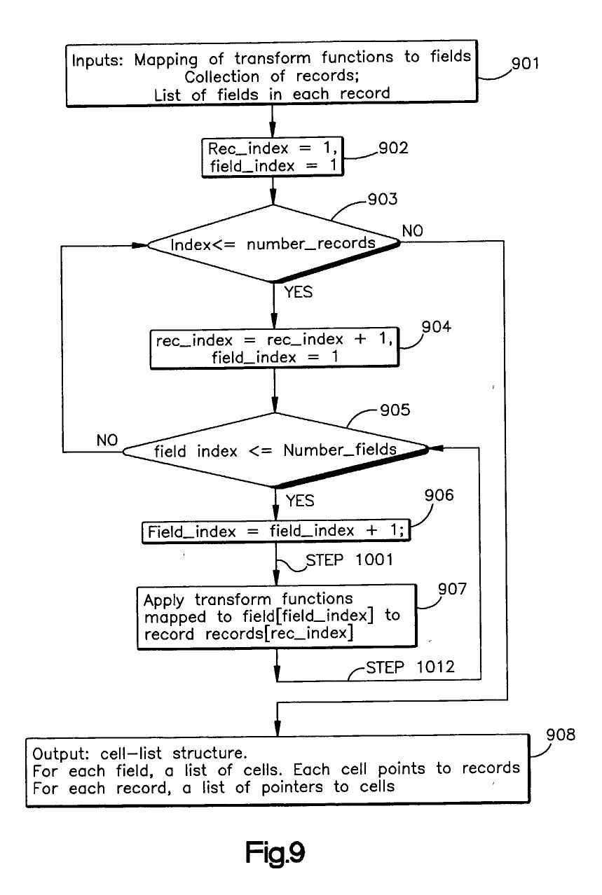

In one example method of updating the cell-list structure (step 804 of FIG. 8), the cell-lists are filled, as illustrated in FIG. 9. In step 901, the inputs are provided, as follows: the mapping of transform functions to fields; the collection of records; and the list of the fields in each record. Following step 901, the method proceeds to step 902. In step 902, the method creates and initializes the variables rec_index and field_index to 1. These variables track the progress of the method during execution, and more specifically, what field of what record is currently being processed. Following step 902, the method proceeds to step 903.

In step 903, the method compares rec_index to the total number of records in the record collection (i.e., the variable number_records). If the rec_index is less than number_records, records remain to be processed and the method proceeds to step 904. If rec_index equals number_records, the method proceeds to step 908 and the method terminates with its output. The output is a cell list structure consisting of a list of cells for each field with each cell pointing to a record and a list of pointers to the cells for each record (FIG. 14).

In step 904, the method increments rec_index and sets field_index equal to 1 to signify the processing of the first field in the next record in the record collection. Following step 904, the method proceeds to step 905. In step 905, the method compares the field index to the total number of fields in each record (i.e., the variable number_fields). If the field_index is less than number_fields, fields in the record remain to be processed and the method proceeds to step 906. If the field_index equals number_fields, the method returns to step 903 to process the next record.

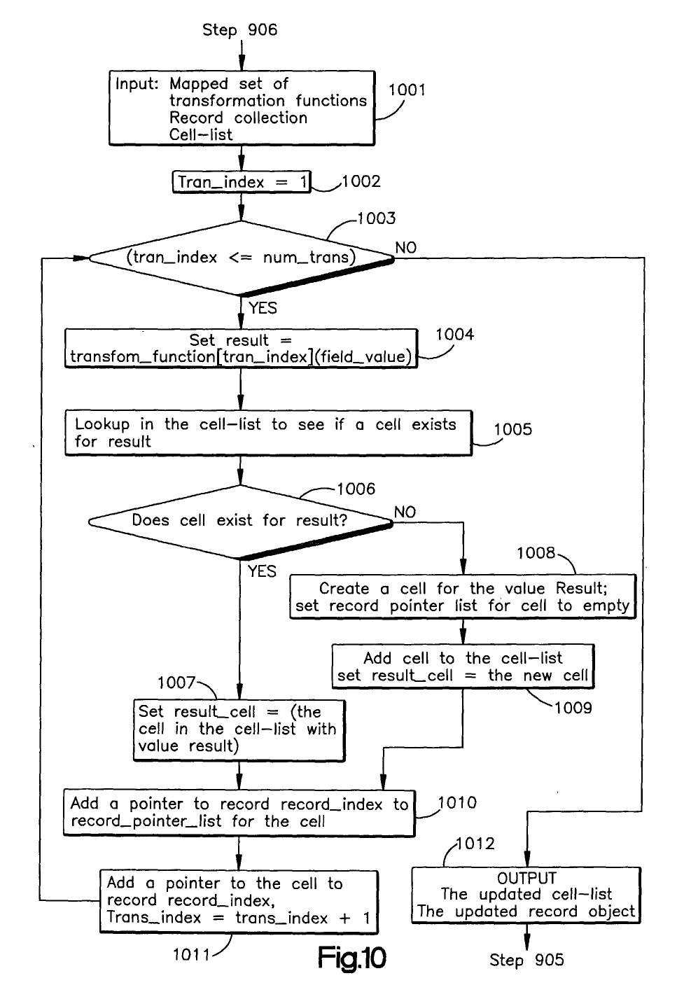

In step 906, the method increments field_index to signify the processing of the next field in the record. Following step 906, the method proceeds to step 907. In step 907, the method applies the transform function(s) mapped to this field (FIG. 10 and described below). Following step 907, the method returns to step 905.

FIG. 10 illustrates one example method of applying transform function(s) to a particular field of a particular record to be updated by the method of FIG. 9 (step 907 of FIG. 9). In step 1001, the inputs are provided, as follows: transform function(s) mapped to this field; a cell list for this field; a record for this record_index; and a field value for this field. Following step 1001, the method proceeds to step 1002. In step 1002, the method creates and initializes the variable tran_index to 1. This variable tracks what transform functions have been applied by the method thus far. Following step 1002, the method proceeds to step 1003. In step 1003, the method compares tran_index to the total number of transform functions associated with this field (i.e., the variable num_trans). If tran_index is less than num_trans, transform functions remain to be applied to this field and the method proceeds to step 1004. If tran_index equals num_trans, the method proceeds to step 1012 and the method terminates with its output. The output is the updated cell list and the record modified by the appropriate transform function(s).

In step 1004, the method applies a transform function to the field value and sets the output to the variable Result. Following step 1004, the method proceeds to step 1005. In step 1005, the method examines the cell list to determine if a cell exists with the value Result. Following step 1005, the method proceeds to step 1006. In step 1006, the method determines whether to create a new cell for the value of Result. If a cell exists for Result, the method proceeds to step 1007. If a cell does not exist for Result, the method proceeds to step 1008.

In step 1007, the method sets the variable result_cell to point to the cell from the cell list that has the value Result. Following step 1007, the method proceeds to step 1010.

In step 1008, the method creates a cell with the value Result and sets the record_pointer list for the cell to empty. Following step 1008, the method proceeds to step 1009. In step 1009, the method adds the created cell for Result to the cell list and sets result_cell to point to the created cell. Following step 1009, the method proceeds to step 1010.

In step 1010, the method adds result_cell to the record_pointer list for the newly created or existing cell. Following step 1010, the method proceeds to step 1011. In step 1011, the method increments tran_index to signify that the application of the transform function tran_index is complete. Following step 1011, the method returns to step 1003.

FIGS. 11-13 illustrate a simple example of the operation of the example system 10. This is a simple case and meant to be only an example of how the system 10 works with one possible implementation. As viewed in FIG. 11, the database has 8 records and each record has 2 fields: FirstName and LastName. The following two transform functions, as described above, are given. The NONE function simply returns the value given to it. The SORT function removes non-alphanumerical characters, sorts all remaining characters in alphabetic or numerical order, and removes duplicates.

The example system 10 creates a list of 8 records (step 801 of FIG. 8), one for each record in the database of FIG. 11. The system 10 creates an empty cell-list for the FirstName field and LastName field (step 802 of FIG. 8). The system 10 decides to apply the NONE transform to the FirstName field and both the NONE and SORT functions to the LastName field (step 803 of FIG. 8). This is just one example of the numerous ways to implement the step of mapping transforms to fields.

The example system 10 constructs the cell-list structure (step 804 of FIG. 8). FIG. 12 illustrates the state of the structure after record 1 has been processed. Record 1 is processed as follows. For the FirstName field, record 1 has “J. G.”. The transform function NONE is applied, resulting in value “J. G.” Since there is no cell in the FirstName cell-list for this value, a cell for “J. G.” is added to the FirstName cell-list. Record 1 points to this new cell and this new cell points to record 1.

For the LastName field, record 1 has “Taylor”. The transform function NONE is applied, resulting in the value “Taylor”. Since there is no cell in the LastName cell-list for this value, a cell for “Taylor” is added to the LastName cell-list. Record 1 points to this new cell and this new cell points to record 1. Next, the transform function SORT is applied to “Taylor”, resulting in “alorTy”. Since there is no cell in the LastName cell-list for this value, a cell for “alorTy” is added to the LastName cell-list. Record 1 points to this new cell and this new cell points to record 1.

FIG. 13 illustrates the status of the cell-list structure after record 2 has been processed. This is only an example of how the system 10 with this example implementation may operate. Record 2 is processed as follows. For the FirstName field, record 2 has “Jimmy”. The transform function NONE is applied, resulting in value “Jimmy.” Since there is no cell in the FirstName cell-list for this value, a cell for “Jimmy” is added to the FirstName cell-list. Record 2 points to this new cell and this new cell points to record 2. For the LastName field, record 2 has “Tayylor”. The transform NONE is applied, resulting in the value “Tayylor”. Since there is no cell in the LastName cell-list for this value, a cell for “Tayylor” is added to the LastName cell-list. Record 2 points to this new cell and this new cell points to record 2. Next, the transform function SORT is applied to “Tayylor”, resulting in “alorTy”. Since there is a cell already for “alorTy” in the LastName cell-list, a pointer from the “alorTy” cell of the LastName cell-list to record 2 is added and a pointer from record 2 to the “alorTy” cell.

The continuing operation of the example system 10 in this manner generates the cell-list structure (step 805 of FIG. 8) shown in FIG. 14 (i.e., after the entire record collection of 8 record objects is processed). The arrows in the figure represent pointers between records. Cells point to appropriate records and records point to appropriate cells (each single bi-directional arrow in FIG. 14 could also be represented by two arrows each going in a single direction).

The middle column of FIG. 14 represents the list of records. The first and third columns of FIG. 14 represent the cell-lists of the outputs of the transform functions for the FirstName and LastName fields, respectively. Each cell in the cell-list is labeled with the output value associated with the cell. The cells in FIG. 14 are ordered from the top. For each different value in the cells in the FirstName field, an output value is associated with it in a FirstName cell-list. For each different value in the cells in the LastName field, an output value is associated with it in a LastName cell-list. Once the cell list structure is in the form partially illustrated in FIG. 14, clustering, matching, and/or merging may be conducted to eliminate duplicate records and produce a cleansed final product (i.e., a complete record collection). The only reason that untransformed values still appear in FIG. 14 is that the simple NONE transform function was utilized for example purposes.

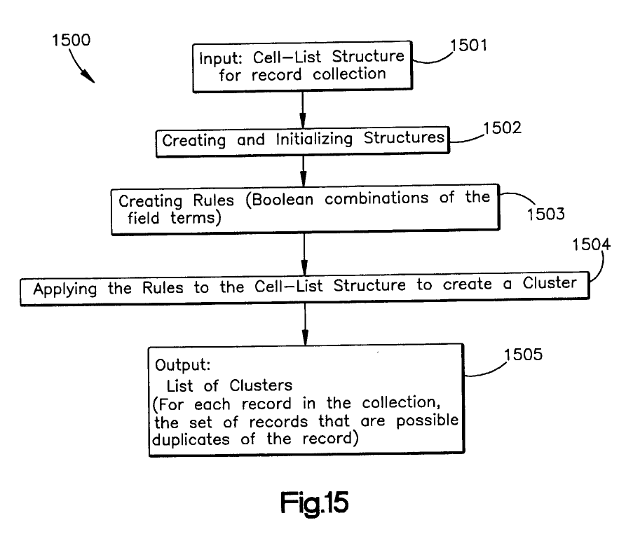

A high level description of a system 1500 in accordance with the present invention is illustrated in FIG. 15. The input 1501 to the system 1500 is the cell-list structure for the record collection (FIG. 14). The cell-list structure represents information for each of the fields about sets of records having similar values for that field. Note that other methods, other than the above-described, may be used to generate the required data that is used as input for the system 1500. The system 1500 may be broken down into the following functional steps: creating and initializing 1502 the structures the system 1500 will use; following step 1502, determining 1503 the similarity criteria for clustering (the similarity criteria are preferably given as Boolean rules that define which record fields (or combinations of record fields) must have similar values for two records to be considered likely to describe the same real-world entity and placed into the same cluster; there are numerous ways to implement this step); and, following step 1503, for each record in the collection, computing 1504 the cluster for that record (the cluster for a record is computed using the information in the cell-list structure).

The output 1505 of the system 1500 is the list of clusters. Each record in the record collection has a cluster associated with it, which each record matching the similarity criteria relative to the other records in its cluster. The system 1500 may thus be divided into the 3 functional steps illustrated in FIG. 15.

The first step 1502 initializes the data structures used (allocating the empty cluster list). The second step 1503 determines the similarity criteria for clustering. The criteria for “most promising” record pair comparisons involve information about whether or not the record pair has the same (or highly similar) value for one or more record fields.

The combination of fields that records must have similar values for to meet these criteria are represented as a Boolean rule. The field names are terms in the rule. The operators are standard Boolean operations (AND, OR, NOT). If two share one or more cells in the cell-list for a field (from the input cell-list structure), they are considered to have similar values for that field and the field name in the rule for this field evaluates to True. Otherwise, the field name in the record evaluates to False. If the entire rule evaluates to true, then the records are considered similar and placed into the same cluster. Otherwise, the records are not considered similar. There are numerous ways to derive rules and “similarity criteria” for a record set. For each record in the record collection, the third step 1504 creates a cluster for that record.

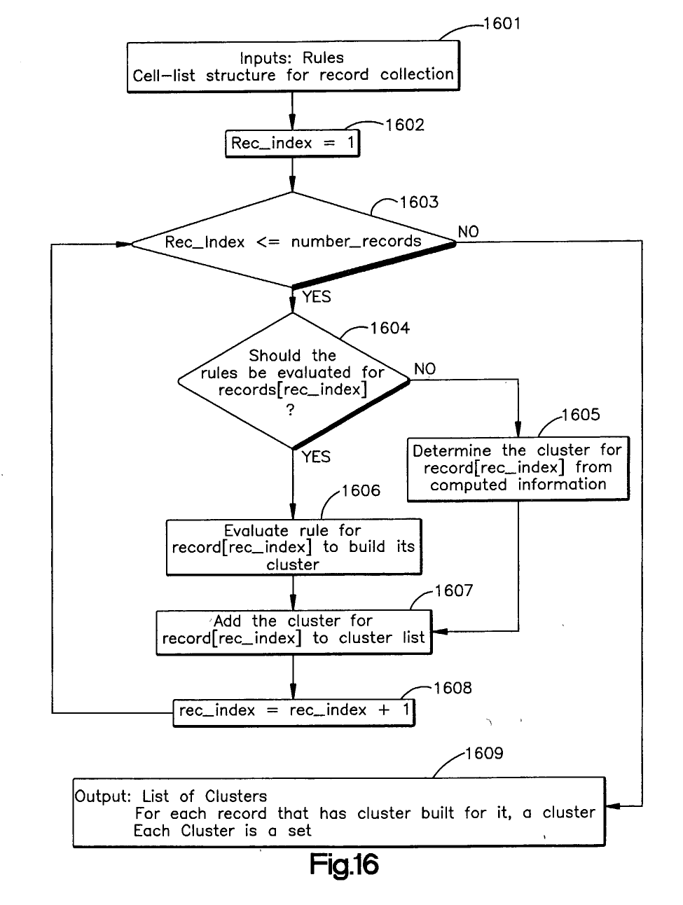

FIG. 16 illustrates an example of the system 1500 of FIG. 15 determining which records should be placed in the cluster for a particular record (step 1504 of FIG. 15). In step 1601, the inputs are provided, as follows: the Boolean rules and the cell-list structure for the record collection. Following step 1601, the system proceeds to step 1602. In step 1602, the system creates and initializes the variable rec_index to 1 This variable tracks the progress of the system during execution, or which record is currently being processed. Following step 1602, the system proceeds to step 1603. In step 1603, the system compares rec_index to the total number of records in the database (i.e., the variable number_records). If rec_index is less than number_records, then records still need to be processed and the system proceeds to step 1604. Otherwise, all records are already processed and the system proceeds to step 1609.

In step 1609, the system provides the output of the list of clusters. This list contains a cluster for every record in the collection. Each record's cluster contains the set of records from the collection identified by the system as possible duplicates of the record.

In step 1604, the system determines if the clustering rules should be evaluated for the current record being processed. If so, the system proceeds to step 1606. Otherwise, it would be more efficient to create the cluster for the current record by examining clusters that have already been built and the system proceeds to step 1605. In step 1605, the system determines the appropriate cluster for the record being processed from computed information.

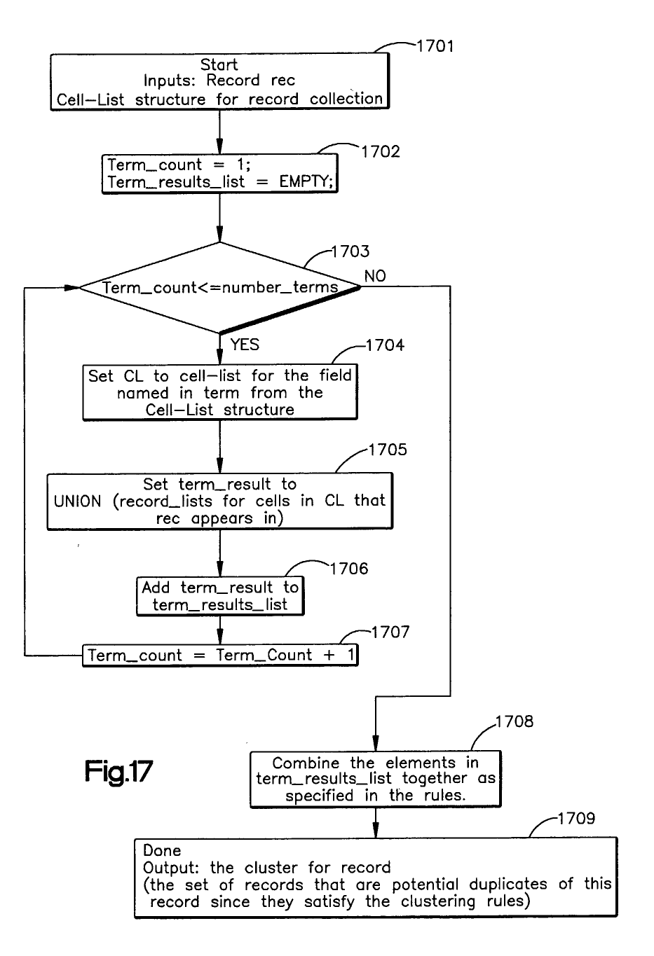

In step 1606 (illustrated more specifically in FIG. 17), the system computes the cluster for the current record by examining clusters that have already been created. Following step 1606, the system proceeds to step 1607. In step 1607, the system adds the cluster for the current record to the list of already computed clusters. Following step 1607, the system proceeds to step 1608. In step 1608, the system increments rec_index to signify the next record in the database will now be processed. Following step 1608, the system proceeds back to step 1603.

FIG. 17 illustrates the system conducting step 1606 of FIG. 16. In step 1701, the system provides the inputs, as follows: the cell-list structure and the current record being processed. Following step 1701, the system proceeds to step 1702. In step 1702, the system creates and initializes the variables term count to 1 and the variable term_results_list to EMPTY. Following step 1702, the system proceeds to step 1703. In step 1703, the system compares term_count to the total number of terms in the clustering rules (i.e., the variable number_terms). If term_count is less than number_terms, then there are still terms in the rule to be processed and the system proceeds to step 1704. Otherwise, all terms in the clustering rule have been evaluated and the system proceeds to step 1708.

In step 1708, the system combines the elements in the term_results_list as specified by the clustering rules. Each term_result in the list associates a field name term from the clustering rule with a list of records (as constructed in step 1705 described below). The records are combined as specified by the clustering rules. The AND operator in the rule corresponds to taking the intersection of the corresponding record sets and the OR operator in the rule corresponds to taking the union of the corresponding record sets. Following step 1708, the system proceeds to step 1709. In step 1709, the system provides output, as follows: the cluster for the particular record (i.e., the set of records from the record collection identified as potential duplicates of that particular record).

In step 1704, the system sets the variable CL to the cell-list in the cell-list structure that corresponds to the clustering rule term that is being evaluated. Following step 1704, the system proceeds to step 1705. In step 1705, the system evaluates a term in the rule. This evaluation involves the identification of the set of records that share at least one cell in the cell-list with the current record rec. Since each cell ion the cell-list has a list of records associated with it, the system computes this set by taking the union of the record lists for the cells in CL in which rec appears. The system sets the variable term_result to this final record set.

Following step 1705, the system proceeds to step 1706. In step 1706, the system adds term_result to term_result_list. Following step 1706, the system proceeds to step 1707. In step 1707, the system increments term count to signify the processing of the next term in the clustering rule. Following step 1707, the system proceeds to step 1703.

As stated in step 1604 of FIG. 16 above, the cluster for a record can be determined one of two ways. The first way (step 1606 of FIG. 16) is to use the cell-list structure to determine which other records satisfy the rules and should be placed in the cluster for that record. To do this, a rule must be evaluated for a record. A process for evaluating a rule is illustrated in FIG. 17. For each of the field names that are terms in the rule, which records share one or more cells with the record in the cell-list for that field is determined. These record sets (one for each of the field name terms) are combined together as specified by the rules. The AND operator in the rule corresponds to taking the INTERSECTION of the record sets. The OR operator corresponds to taking the UNION of the record sets. The final record set is the cluster for the record, since for these records the rules evaluate to true.

The second way (step 1605 in FIG. 16) is to use clusters already computed to derive the set of records that should be in the cluster for the record. Depending on the application, it might be possible to use the clusters that have already been computed to determine what records should be in the cluster for the record. There are numerous ways to implement this second way.

A simple example for the sample database of customer names in FIG. 11 is traced below. This is a simple case and meant to be only an example of how the system 1500 works with one possible implementation. The database has 9 records and each record has 2 fields: FirstName and LastName. The cell-list structure in FIG. 14 has already been constructed, as described above.

For step 1, an empty list of clusters is created. For step 2, the system decides that two records should be considered “possible duplicates” if they have a similar value for either the FirstName or LastName field. The Boolean rule describing this “similarity criteria” would be (FirstName OR LastName). Two records are considered to have a similar value for a field if they share one or more cells in the cell-list for that field. So, for a first record to satisfy this rule relative to a second record, the first record would have to share at least one cell with the second record in either the cell-list for the FirstName field or the cell-list for the LastName field. There are numerous ways to derive rules and “similarity criteria” for a record set. This rule is a very simple example of possible types of rules. For real-world applications, similarity rules can have a large number of terms with many Boolean operators.

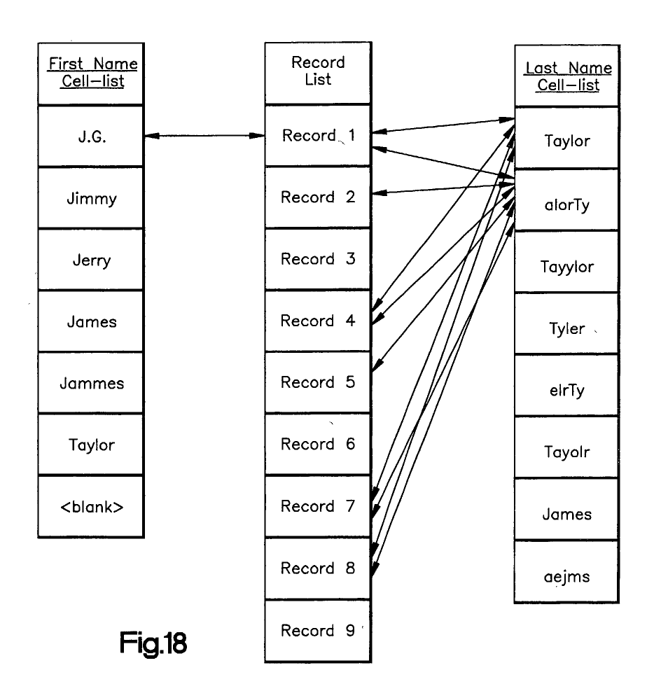

Step 3 of the system involves applying the rules to the cell-list structure to actually construct the clusters. FIG. 18 shows the portion of the sample cell-list structure needed for finding the cluster for Record 1. Record 1 would be processed, as follows:

Record 1 is associated with cell 1 in the FirstName cell-field (as indicated by the arrow in the diagram from the cell 1 to record object 1). Record 1 is the only record associated with cell 1 in the FirstName cell-list, and no other record shares a cell in the FirstName cell-list with record 1.

Record 1 is associated with cells 1 and 2 in the LastName cell-list. Records 1, 4, .7 and 8 are associated with cell 1 in the cell-list while records 1, 2, 4, 5, 7, 8 are associated with cell 2. Thus, records 1, 2, 4, 5, 7, 8 all share at least one cell with record 1 in the LastName cell-list.

The rule (FirstName OR LastName) is evaluated for this information. Records 1, 2, 4, 5, 7, 8 share a cell with record 1 in either the FirstName cell-list or LastName cell-list, so these records satisfy the rule and become the cluster for record 1. This cluster is added to the cluster list.

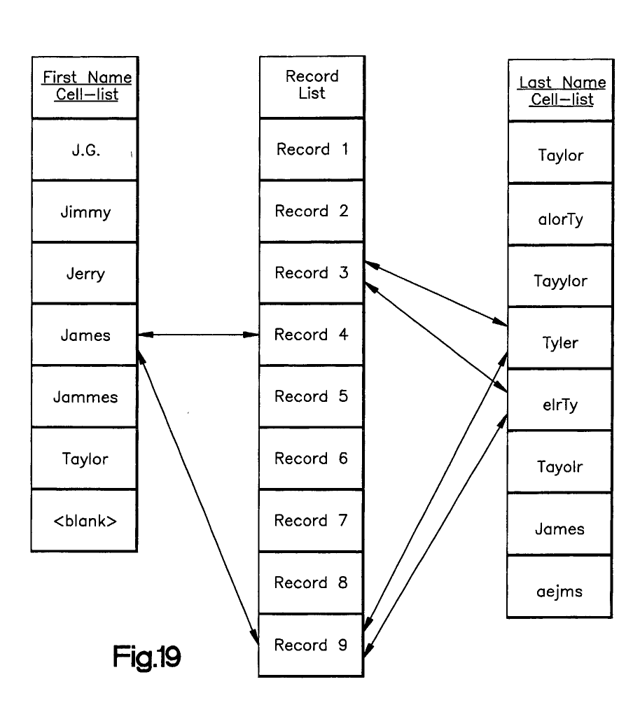

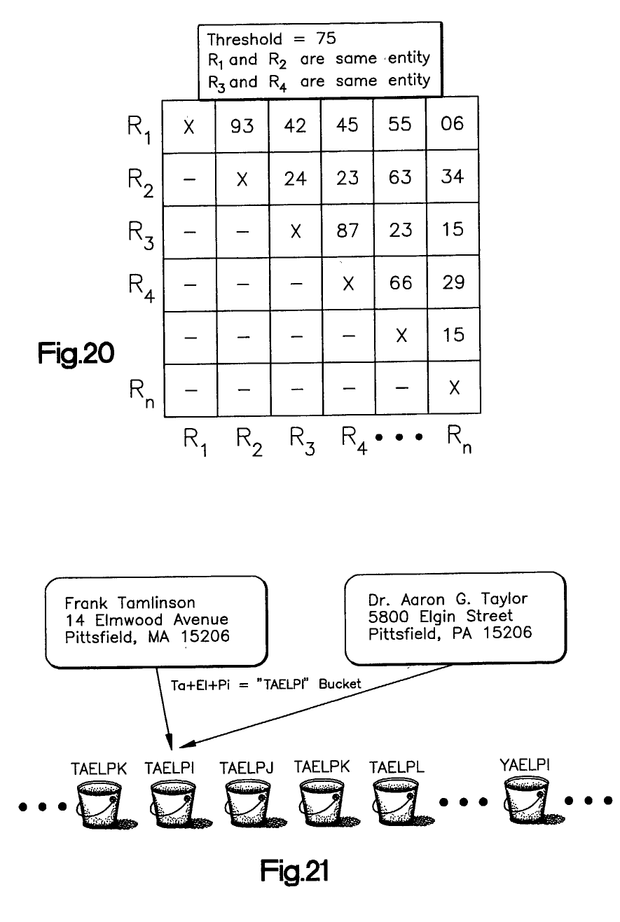

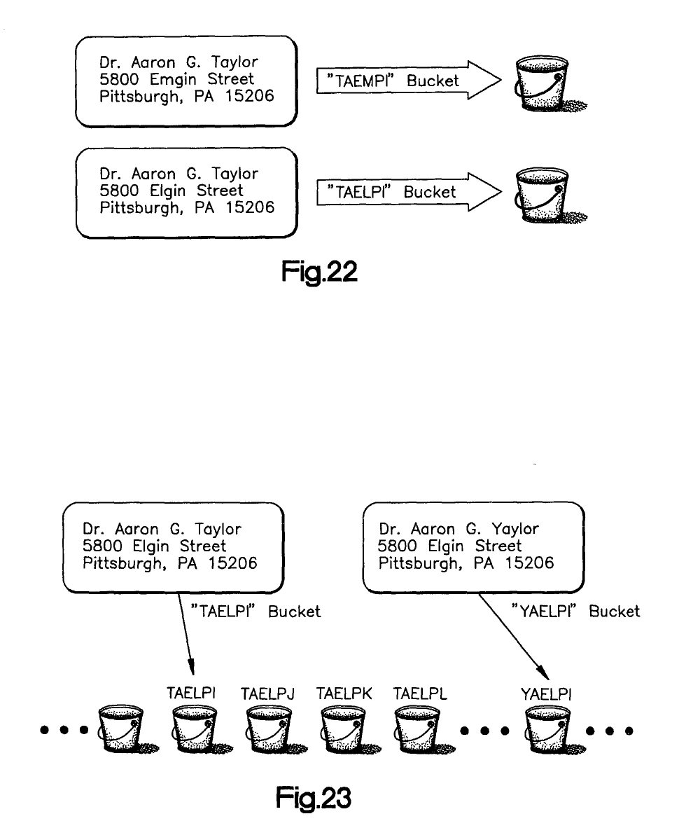

Another example is shown for the creation of the cluster for Record 9 (FIG. 19). Record 9 would be processed, as follows:

Record 9 is associated with cell 4 in the FirstName cell-field (as indicated by the arrow in the diagram from the cell 1 to record object 1). Records 4 and 9 are associated with cell 4 in the FirstName cell-list. Thus, records 4 and 9 share a record with a cell-list.

Record 1 is associated with cells 4 and 5 in the LastName cell-list. Records 3 and 9 are the only records associated with both cells 4 and 5 in the cell-list. Thus, only record 9 shares at least one cell with record 9 in the LastName cell-list.

The rule (FirstName OR LastName) is evaluated for this information. Records 3 and 4 share a cell with record 9 in either the FirstName cell-list or LastName cell-list, so these records satisfy the rule and become the cluster for record 9. This cluster is then added to the cluster list.

From the above description of the invention, those skilled in the art will perceive improvements, changes and modifications. Such improvements, changes and modifications within the skill of the art are intended to be covered by the appended claims.

Having described the invention, I claim the following:

1. A system for identifying similar records, said system comprising:
a collection of records, each said record in said collection having a list of fields and data contained in each said field;
a set of Boolean rules for operating upon the data in each said field;
a cell list structure generated from said collection of records,
said cell list structure having a list of cells for each field and a list of pointers to each said cell of said list of cells for each said record,
said set of Boolean rules identifying the similar records from said cell list structure.

2. The system as set forth in claim 1 wherein said collection of records is formed by parsing data for each said record into fields.

3. The system as set forth in claim 1 wherein said set of Boolean rules operate upon the data during a clustering step of a data cleansing operation.

4. A method for cleansing electronic data, said method comprising the steps of:
inputting a collection of records, each record in the collection representing an entity having a list of fields and data contained in each of the fields;
selecting a plurality of Boolean clustering rules for operating upon the data in each field in each record;
generating a list of clusters by applying the plurality of Boolean clustering rules to the collection of records, the list of clusters comprising a list of candidate duplicate records determined by the plurality of Boolean clustering rules; and
outputting the list of clusters.

5. The method as set forth in claim 4 further includes the step of parsing the data for each said record into fields.

6. The method as set forth in claim 4 further includes the step of correcting errors in the data by reference to a recognized source of correct data.

7. The method as set forth in claim 4 further includes the step of merging the list of candidate duplicate records from said outputting step together to eliminate records representing the same entity.

8. A system for identifying similar records, said system comprising:
a collection of records, each said record in said collection having a list of fields and data contained in each said field;
a set of fuzzy logic rules for operating upon the data in each said field;
a cell list structure generated from said collection of records,
said cell list structure having a list of cells for each field and a list of pointers to each said cell of said list of cells for each said record,
said set of fuzzy logic rules identifying the similar records from said cell list structure.

9. The system as set forth in claim 8 said set of fuzzy logic rules is included in a hierarchy of rules.

10. The system as set forth in claim 9 further including a set of conditions for applying to said hierarchy of rules.
